(19) United States
(12) Patent Application Publication
(10) Pub. No.: US 2002/0184650 A1
(43) Pub. Date: Dec. 5, 2002

(54) Means to provide a settop box user with the option of removing unsubscribed programs/services from an electronic program guide when viewing guide information

(75) Inventor: Christopher J. Stone, Newtown, PA (US)

Correspondence Address: VOLPE AND KOENIG, PC, DEPT MOT, SUITE 400, ONE PENN CENTER, 1617 JOHN F. KENNEDY BOULEVARD, PHILADELPHIA, PA, 19103, US

(73) Assignee: General Instrument Corporation, Horsham, PA

(21) Appl. No.: 09/867,922

(22) Filed: May 30, 2001

(51) Int. Cl. H04N 7/16; G06F 3/00; H04N 5/445; G06F 13/00; H04N 7/173

(52) U.S. Cl. 725/131; 725/46; 725/25

(57) ABSTRACT

The present invention is a system and method for displaying a program guide. This system comprises a tuner for receiving information from a CATV provider relating to programs/services, which includes a program guide. Coupled to the tuner is a system processor which filters the information and outputs a program guide filtered according to the programs/services which the system processor is authorized to receive.

### BACKGROUND

The present invention generally relates to a cable TV system which provides an electronic programming guide (EPG). More specifically the invention relates to a cable TV system which supports a more user friendly EPG to provide the subscriber with quicker access to available programs/services that the subscriber is authorized to view.

Technological advances in electronics and computer software in the information services field has made available a profusion of information that can be quickly accessed. Today, CATV communication systems are capable of providing over five hundred individual channels for delivering video, audio and other data services. Regional bell operating companies (RBOCs) now compete with CATV providers for video and audio program delivery in addition to providing traditional telephone services. As a result of the diversity and proliferation of information services, subscribers are now faced with an overwhelming amount of information sources from which to choose.

Electronic program guides (EPGs), which present a schedule of programs in progress and upcoming programs, are capable of displaying only a limited number of programs at any one time when using a television set as a display. With CATV systems projected to offer over five hundred channels of programming it is impractical to display all of the program choices.

There have been systems developed which have attempted to alleviate the problems and frustration resulting from a large number of programming choices. Some systems require the subscriber to develop a search strategy and specify the desired service choosing from a number of genres available on the system such as movies, sports, comedies, dramas, educational shows, etc. Subscribers select one or more of these genres and the system provides a list of alternatives to their selection. However, with the growing number of program offerings, this filtered list can still result in a large number of programming choices which the subscriber must scroll through to find a program for which the subscriber is authorized to select. This results in the same problems and frustration encountered with an unfiltered list, especially when the subscriber is not authorized to view a majority of the list channels.

Accordingly, there exists a need for an information service selection system which operates transparently or without extensive subscriber involvement by filtering the complete information list of channels in order to display the channels that are subscribed to by the user.

Objects and advantages of the present invention will become apparent to those skilled in the art after reading the detailed description of a presently preferred embodiment.

### SUMMARY

The present invention is a system and method for displaying a program guide. This system comprises a tuner for receiving information from a CATV provider relating to programs/services, which includes a program guide. Coupled to the tuner is a system processor which filters the information and outputs a program guide filtered according to the programs/services which the system processor is authorized to receive.

### BRIEF DESCRIPTION OF DRAWINGS

FIG. 1 is a simplified diagram of a CATV transmission infrastructure;

FIG. 2 is plot of the upstream and downstream transmission frequencies;

FIG. 3 is a settop terminal made in accordance with the teachings of the present invention;

FIG. 4 is a menu page depicting a typical CDC generated electronic programming guide; and

FIG. 5 is a flow diagram of the operation of the information selection system in accordance with the preferred embodiment of the present invention.

### DETAILED DESCRIPTION OF THE PREFERRED EMBODIMENT

The preferred embodiment will be described with reference to drawing figures wherein like numerals represent like elements throughout.

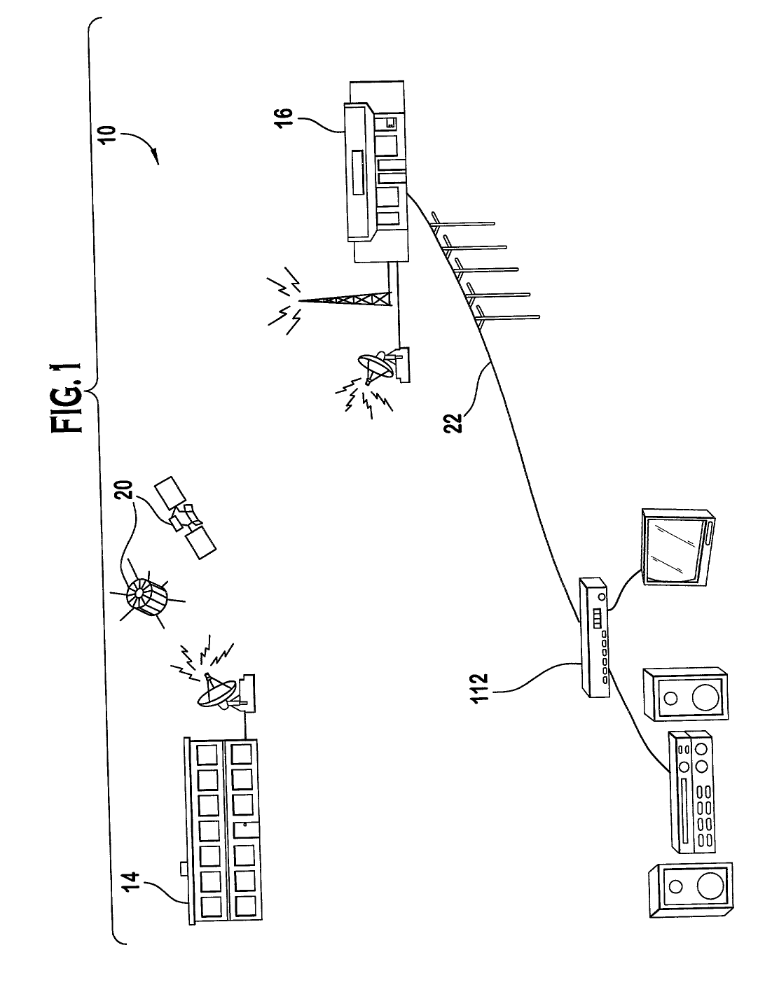

A CATV communication network 10 embodying the present invention is shown in FIG. 1. The communication network 10 generally comprises one or more uplinks 14 which communicate with a plurality of headends 16, each of which in turn, communicates with a plurality of settop terminals 112. Each settop terminal 112 receives the transmissions from the headend 16 through the CATV network 22. The network 22 may comprise a standard coaxial network, a hybrid fiber-coax network or a “wireless cable” network comprising microwave antennas and receivers. The settop terminals 112 are the user interface between a subscriber, the subscriber's television and the communication network 10.

The uplink 14 is located remotely from the headends 16 and communicates with the headends 16 via a satellite link 20. The uplink 14 generally originates all in-band video and audio programming for specific channels including live or archival broadcasts or interactive service content, (for example, movies, electronic encyclopedias, electronic catalogs, downloadable applications, movies, etc.). The information on a given channel may comprise analog video and audio, digital audio, digital data, or any combination thereof. The in-band programming information is transmitted to the uplink 14 from a plurality of separate originating sources and combined at the uplink 14 before being forwarded to the headends 16. Alternatively, a plurality of uplinks 14 may independently provide the in-band programming information to each headend 16 which will receive and coordinate the transmissions from the uplinks 14.

The headend 25 is the origination source, or the retransmission point, of all out-of-band information sent to the settop terminals 112, for example, electronic programming guides (EPG), subscriber billing information and settop terminal control data. Since the out-of-band information 34 originates with the CATV operator, the information displayed to the subscriber such as a programming guide, is customizable by the CATV operator.

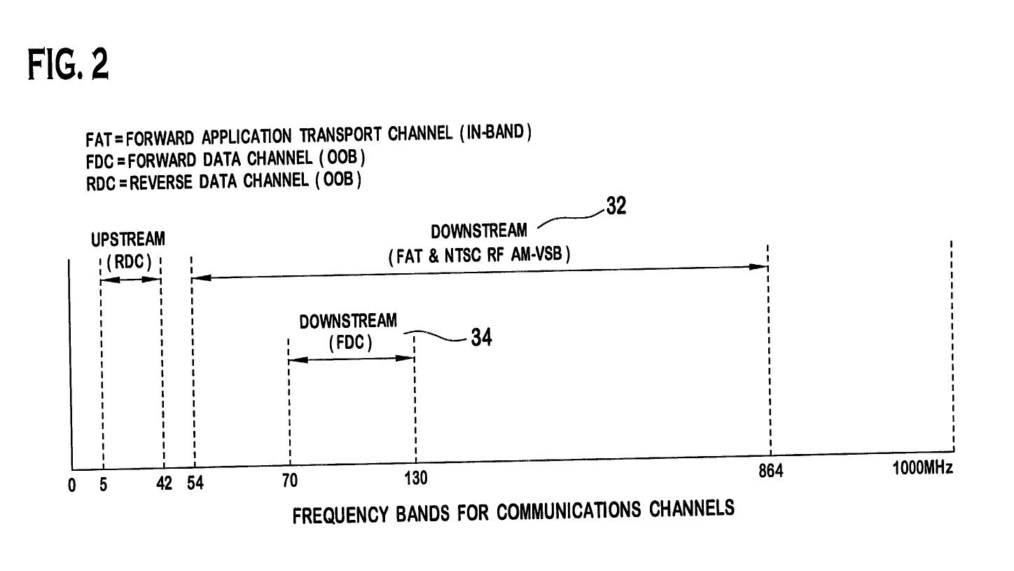

Control and program data are forwarded to the settop terminals 112 over a specific channel known as the forward data channel (FDC) 34, which can be transmitted over any one of the frequencies 70-130 MHz as shown in FIG. 2. After the headend 16 receives the video with audio and/or digital audio programming from the uplink 14, the programming is selectively placed on 6 MHz channels as designated by the CATV operator and transmitted to settop terminals 112 over the CATV transmission network 22. In addition to forwarding programming received from the uplink 14, the headend 16 may also locally originate analog in-band audio or video channels.

The settop terminal 112 receives in-band information over the forward application transport (FAT) channels 32, which may be located in any one of the frequencies 54-864 MHz, excluding those allocated for the FDC 34, and out-of-band information over the FDC 34. The settop terminal 112 receives the broadcast transmissions, decrypts the program, if encrypted at the headend 16, and processes the information for receipt by the subscriber. The settop terminal 112 also demodulates and demultiplexes the digital data stream, and converts a portion of the digital stream to analog if the stream contains digital audio, and performs other data manipulation as necessary.

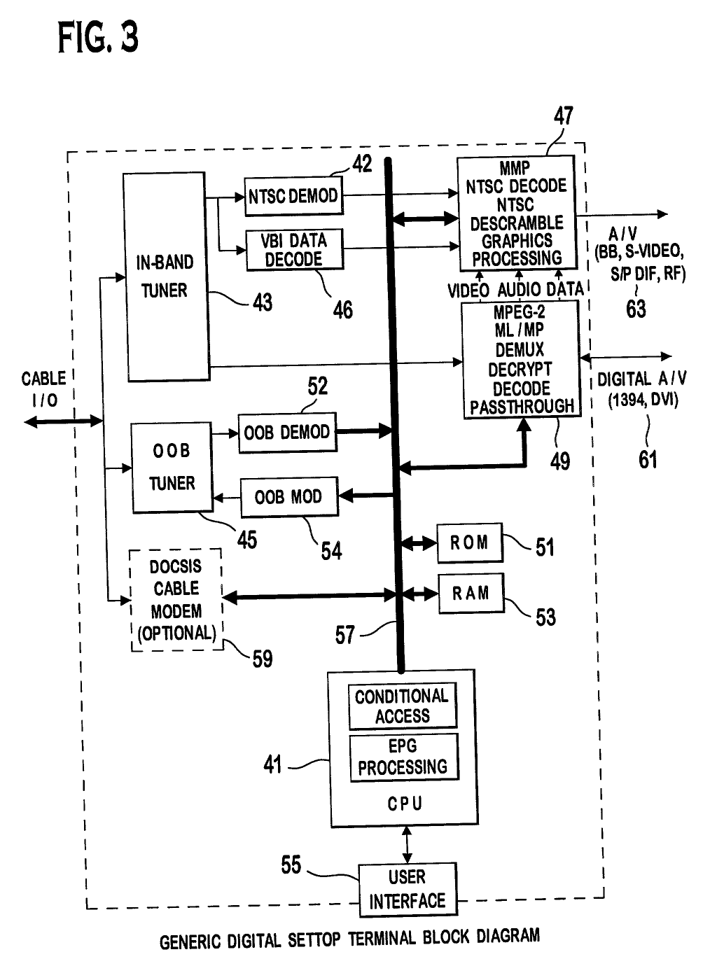

Referring to FIG. 3, a settop terminal 112 made in accordance with the present invention is shown as a block diagram. The settop terminal 112 includes a CPU 41, a frequency agile in-band tuner 43, a frequency agile (out-of-band) OOB tuner 45, a multimedia processor 47, an MPEG-2 processor 49, ROM 51, RAM 53, a user interface 55, an NTSC Demod 42, a VBI Data Decode 46, an OOB Demodulator 52, an OOB Modulator 54, and may contain a DOCSIS cable modem 59. A system bus 57 facilitates communications between the various processors within the settop terminal 112.

The frequency agile OOB tuner 45, or if installed a DOCSIS cable modem 59, provides a data interface between the CPU 41 and the CATV headend 25. The OOB tuner 45 and/or DOCSIS cable modem 59 receives the out-of-band downstream data transmissions from the headend 25 which is transmitted over the FDC 34. The OOB demodulator 52 then demodulates the transmission. Any information to be transmitted to the headend 25 is modulated by the OOB modulator 54 and transmitted to the headend 25 through the OOB tuner 45.

The CPU 41 provides overall control of the settop terminal 112. The CPU 41 reads code from the ROM 51 when initially powered on to initialize all of the other system components. The RAM 53 stores updated control or authorization information and any executable instructions or programs sent from the headend 25, and program characteristics. Those skilled in the art know that a settop terminal may contain a plurality of system processors.

If the user selects an analog channel for viewing, then the frequency agile in-band tuner 43 demodulates the carrier frequency of a channel selected by the subscriber. Audio and video content is processed through the MMP processor 47 in a manner that is well known to those familiar with this art. If the user selects a digital channel for viewing, then the frequency agile in-band tuner 43 tunes to a frequency as defined in the Virtual Channel Table, demodulates the QAM encoded signal, demultiplexes the embedded transport stream, acquires the PAT, and acquires the PMT associated with the user selected channel as defined in the PAT. The audio and/or video streams are then parsed from the transport stream based on the PIDs as defined in the PMT. Audio and video content is processed through the MPEG-2 processor 49 in a manner that is well known to those familiar with this art. The audio and video may be presented to the user in either an analog and/or digital format. Analog formats 63 consist of any combination of one or more of the following: 1) audio and video modulated on a second intermediate carrier frequency corresponding to NTSC TV channels 3 or 4, 2) video presented in a composite (baseband) format, 3) video presented in a component format (S-video, YPbPr or RGB), 4) audio presented in stereo (right and left) baseband format, 5) audio presented in S/P-DIF format, and 6) any other possible technologies not previously described. Digital formats 61 consist of any combination of one or more of the following: 1) audio and video digitized and transmitted over IEEE-1394, 2) audio and video digitized and transmitted over DVI, and 3) any other possible technologies not previously described.

A user interface 55 is provided for permitting a subscriber to select from one of the available program choices. The user interface 55 may be any type of input device such as an IR remote controller, a keyboard, a mouse, a joystick, a voice recognition system, or may be via a front panel button/knob.

In operation, a subscriber tunes the settop terminal 112 to a desired broadcast channel 32 in order to watch and/or listen to a particular program. The program content information received on the broadcast channels 32 is in-band information. As is well known by those skilled in the art, frequency-agile broadband RF tuners typically include a separate FM “tap”, or receiver, which is for receiving the narrowband FDC 34. Most settop terminals 112 are pre-set to a specific FDC 34 by the manufacturer.

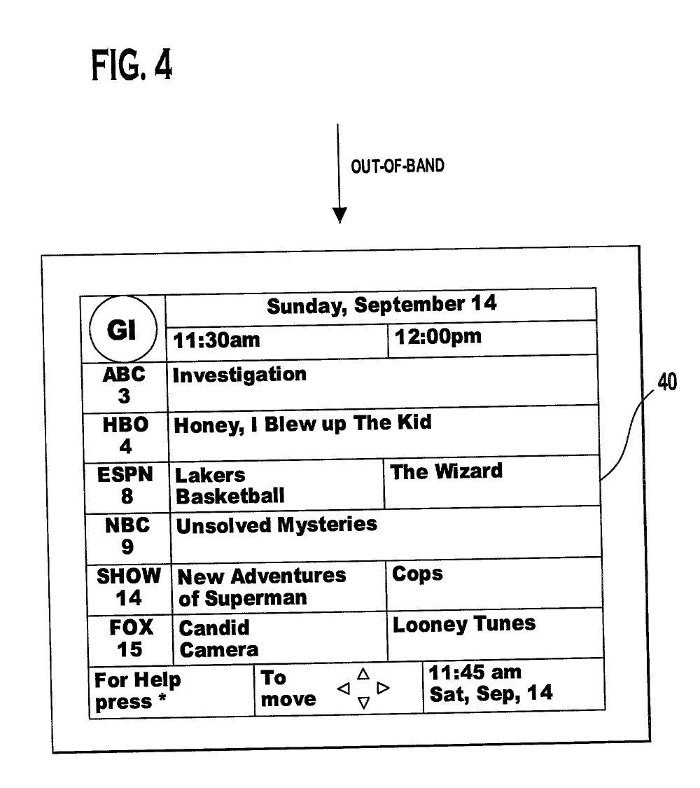

A subscriber may also view out-of-band information in the form of an electronic program guide (EPG) 40, as shown in FIG. 4. This information is typically downloaded by the CATV operator at the headend 16 into the memory within settop terminal 112 via the FDC 34. As those skilled in the art know, there are methods which allow the EPG to be viewed by the subscriber, listing all available programs by a category, such as time, movie, etc. . . . , depending on the subscriber's preference. Each settop terminal 112 receives the composite signal from the headend which comprises the EPG 40, authorization information, and service codes. The EPG 40 is displayed when the subscriber requests it by pressing a button on the user interface 55, or by requesting the channel which has been set aside by the CATV operator to display the EPG 40, listing all available programs/services by some predetermined category, using the service codes associated with the program/service.

In the preferred embodiment of the present invention, the information selection system also provides a means for filtering the EPG 40 to display only those programs/services for which the subscriber is authorized. The subscriber may view this filtered EPG 40 by selecting this option with the user interface 55, which may be in the form of a button on the user interface 55. The filtered EPG 40 may also be viewed through an on-screen menu. This menu allows the subscriber to choose between viewing the entire EPG 40, containing all available channels or the filtered EPG 40, containing only authorized channels, (i.e., 1. Authorized channels only, 2. All available channels).

Alternatively, the information selection system may utilize the one channel set aside by the CATV operator for display of the EPG 40. In order to display the filtered EPG 40, the subscriber may press a “filter” button located on the user interface 55. The settop terminal 112 would then format the EPG 40 to display only those channels for which the subscriber is authorized.

In still another alternative embodiment, the display of only those programs/services for which the subscriber is authorized can be accomplished through the use of a designated channel set aside for the specific purpose of displaying the EPG 40 in this format. Similar to displaying the unfiltered EPG 40, the CATV operator can send the filtered EPG 40 over a separate channel when the subscriber selects this channel with the user interface 55.

Even though specific alternatives have been discussed by which the subscriber is able to choose to filter the EPG 40 to display only those channels for which the subscriber is authorized, those skilled in the art know that there may be other ways to allow the subscriber to choose this type of EPG 40 display without detracting from the scope of the present invention.

Referring back to FIG. 3, the selection by the subscriber to display only those programs/services for which they are authorized is processed by a conditional access processor within the CPU 41 of the settop terminal 112. As known by those skilled in the art know, although the settop terminal is illustrated with one conditional access processor within the CPU, a settop terminal may be made with multiple conditional access processors that are located within the CPU or separate from the CPU. The function of conditional access processor, regardless of where it is located, is the same. For the purposes of this disclosure though, only one conditional access processor will be discussed. In accordance with the preferred embodiment of the present invention, the conditional access processor of the CPU 41 of an analog settop terminal 112 reads the service codes transmitted within the VBI from all available analog programs/services and compares the service codes with authorization information. For those channels which the subscriber is authorized to receive, the CPU 41 processes the programs/services and outputs the appropriate filtered EPG 40 listing only authorized programs/services.

A digital settop has a variety of means with which it may obtain authorization for programs/services. For analog programs/services, the digital settop terminal may read the service codes transmitted within the VBI of all available analog programs/services. For both analog and digital programs/services, the digital settop may obtain the authorization information for the programs/services from an Entitlement Management Message (EMM) and the Virtual Channel Table (VCT). The settop terminal may also be provided with a table and/or database, be it a modified Virtual Channel Table or some other type of table and/or database, which is transmitted to the settop from the service provider. The table and/or database would contain the programs/services that the subscriber is authorized to receive, thus eliminating the need for the settop to obtain and compile this information from the VBI and/or EMM. Similar to an analog settop terminal, the conditional access processor contains the means of determining which programs/services the user is authorized, whether the processor is located within the system processor or separate therefrom.

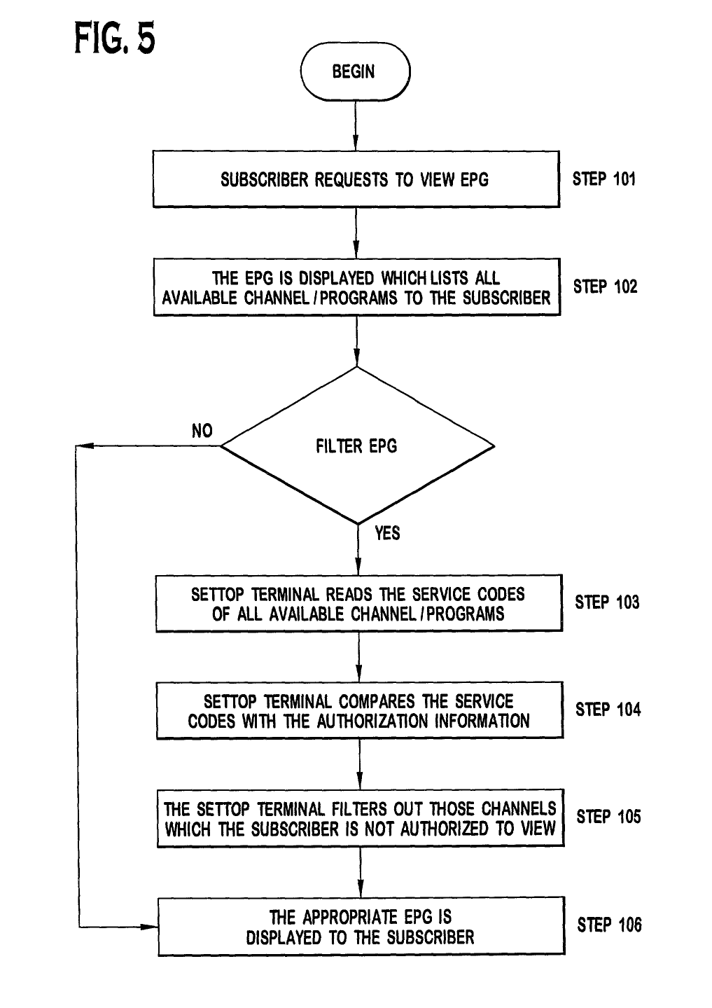

The flow diagram of the information selection system in accordance with the preferred embodiment is illustrated in FIG. 5. When the subscriber makes a request to view the EPG 40 (step 101), the settop terminal 112 displays the EPG 40 sent from the headend for all programs/services that are available (step 102). If the subscriber makes a request to display only those channels for which the subscriber is authorized, the settop terminal 112 reads the service codes of each channel/program (step 103) and compares the service codes with the authorization information (step 104) and filters out those channels the subscriber is not authorized to receive (step 105). For those programs/services the subscriber is authorized to receive, the settop terminal 112 displays the appropriate EPG 40 to the subscriber (step 106). If the subscriber does not request filtering of the EPG 40, the settop terminal 112 displays the EPG 40 containing authorized and unauthorized channels to the subscriber (step 106).

Providing the user with the option of removing programs/services that the subscriber currently is not subscribed to from the EPG 40 creates a more user friendly EPG 40 by removing excess information that the user has no use for. This concept also provides the user with quicker access to available programs/services that the subscriber may view without having to sort through those which the subscriber cannot view.

Although the invention has been described in part by making detailed reference to the preferred embodiment, such detail is intended to be instructive rather than restrictive. It will be appreciated by those skilled in the art that many variations may be made in the structure and mode of operation without departing from the spirit and scope of the invention as disclosed in the teachings herein.

What is claimed is:

1. A settop terminal for displaying a program guide comprising:
a tuner for receiving information from a CATV provider relating to programs/services, said information comprising a program guide, and
a system processor coupled to said tuner for filtering the information and outputting a program guide filtered according to the programs/services which the system processor is authorized to receive.

2. The settop terminal of claim 1 wherein said settop terminal is an analog settop terminal for receiving analog information from said CATV provider relating to programs/services.

3. The settop terminal of claim 1 wherein said settop terminal is a digital settop terminal for receiving one of analog, digital and both analog/digital information from said CATV provider relating to programs/services.

4. The settop terminal of claim 1 wherein said system processor filters said information in response to a request by a subscriber.

5. The settop terminal of claim 4 wherein the request is a selection of a channel containing filtered information.

6. The settop terminal of claim 4 wherein the request is entered by an operating control member.

7. The settop terminal of claim 6 wherein the operating control member enters the request over a wireless transmission path.

8. A method for displaying a program guide comprising the steps of:
receiving information from a CATV provider relating to programs/services, said information including the program guide,
filtering said information, and
outputting a program guide filtered according to the programs/services which the system processor is authorized to receive.

9. The method of claim 8 wherein said information further includes authorization data and service data.

10. The method of claim 9 wherein authorization data and service data are compared to filter said information.

11. The method of claim 8 wherein said information is analog information.

12. The method of claim 8 wherein said information is analog, digital and both analog/digital information.

13. The method of claim 8 further comprising the steps of requesting said program guide filtered according to the programs/services which the system processor is authorized to receive.

14. The method of claim 13 wherein the request is a selection of a channel containing filtered information.

15. The method of claim 13 wherein the request is entered by an operating control member.

16. The method of claim 15 wherein the operating control member enters the request over a wireless transmission path.

17. A settop terminal for displaying a program guide arranged in one of a first mode and second mode comprising:
a tuner for receiving information from a CATV provider relating to programs/services, said information comprising the program guide, being arranged in a first mode; and
a system processor coupled to said tuner for filtering the information and outputting a filtered program guide arranged in said second mode.

18. The settop terminal of claim 17 wherein said first mode includes all available programs/services made available by said CATV provider.

19. The settop terminal of claim 17 wherein said second mode includes only programs/services which the system processor is authorized to receive.

20. The settop terminal of claim 17 wherein said settop terminal is an analog settop terminal for receiving analog information from said CATV provider relating to programs/services.

21. The settop terminal of claim 17 wherein said settop terminal is a digital settop terminal for receiving analog, digital and both analog/digital information from said CATV provider relating to programs/services.

22. The settop terminal of claim 17 wherein said system processor filters said information in response to a request by a subscriber.

23. The method of claim 22 wherein the request is a selection of a channel containing filtered information.

24. The method of claim 22 wherein the request is entered by an operating control member.

25. The method of claim 23 wherein the operating control member enters the request over a wireless transmission path .
